(19) United States
(12) Patent Application Publication
(10) Pub. No.: US 2025/0108962 A1
(43) Pub. Date: Apr. 3, 2025

(54) STORAGE BOX AND VEHICLE

(71) Applicant: Guangzhou Tufa network technology Co., LTD, Guangzhou (CN)

(72) Inventors: He YANG, Guangzhou (CN); Yi SHI, Guangzhou (CN)

(73) Assignee: Guangzhou Tufa network technology Co., LTD, Guangzhou (CN)

(21) Appl. No.: 18/973,083

(22) Filed: Dec. 8, 2024

Related U.S. Application Data
(63) Continuation of application No. PCT/CN2024/113810, filed on Aug. 22, 2024.

(30) Foreign Application Priority Data
Oct. 1, 2023 (CN) 202322680494.X

(51) Int. Cl. B65D 43/16; B60R 9/00

(52) U.S. Cl. CPC B65D 43/16; B60R 9/00

(57) ABSTRACT

The present disclosure provides a storage box and a vehicle. The storage box includes a box body, a box cover, and a cover opening structure. The cover opening structure is configured to guide the box cover to switch from a closed state to an opening state in which an accommodating cavity is opened, or guiding the box cover to switch from the opening state to the closed state. The cover opening structure for guiding the box cover to switch between the opening state and the closed state is disposed in the accommodating cavity such that the opening of the storage box is not affected by an external environment. Moreover, the cover opening structure does not occupy the original space of the vehicle such that the storage box is suitable for use in the vehicle.

### RELATED APPLICATIONS

This application is a continuation application of PCT application No. PCT/CN2024/113810, filed on Aug. 22, 2024, which claims the benefit of priority of Chinese application number CN 202322680494X filed on Oct. 1, 2023, and the contents of the foregoing documents are incorporated herein by reference in entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technical field of vehicles, and in particular, to a storage box and a vehicle.

### BACKGROUND

With the development of science and technology, various commuter vehicles have emerged, bringing great convenience for people's life. Especially, short-distance commuter vehicles have been increasingly used, such as kick scooters, tricycles, self-balancing scooters. These short-distance vehicles can be driven by people standing thereon, are small and portable, suitable for traveling through narrow spaces, and have advantages in ultra-short distance traveling. Storage boxes are usually provided on short-distance commuter vehicles to store articles. A hinge of a storage box in the existing technology is generally in the form of a physical shaft, which occupies a large space and may reduce the original space of a vehicle. When a desired position of the physical shaft is occupied by other components, the storage box cannot be used. In the present disclosure, the term commuter vehicle refers to any type of transportation designed primarily for short-distance travel, typically for daily commutes to and from work, school, or other regular destinations. Commuter vehicles in the present disclosure are intended to provide convenience, efficiency, and reliability for frequent use and can include a wide range of modes of transport such as, but not limited to, bicycles, electric bikes, scooters (e.g., kick scooters, mobility scooters, electric scooters), self-balancing personal transporters (e.g., self-balancing scooters, hoverboards, self-balancing unicycles), motorcycles, compact cars, and personal mobility devices, etc.

Therefore, there is a need to provide a storage box having a more reasonable structure.

The content in the background section is merely information known to the inventors, and neither represents that the above information has been found in the public domain prior to the filing date of the present disclosure nor represents that it can become the prior art of the present disclosure.

### SUMMARY

The present disclosure provides a storage box that can solve the problem in the related art.

In a first aspect, the present disclosure provides a storage box, including: a box body; a box cover disposed to cover the box body and forming an accommodating cavity with the box body, where the accommodating cavity is configured to accommodate an object; and a cover opening structure disposed in the accommodating cavity, where the cover opening structure is configured to guide the box cover to switch from a closed state to an opening state so as to open the accommodating cavity, or guide the box cover to switch from the opening state to the closed state.

In a second aspect, the present disclosure provides a vehicle, including a vehicle body including the storage box according to the first aspect of the present disclosure.

To sum up, the storage box and the vehicle provided in the present disclosure have the following advantages: a cover opening structure for guiding a box cover to switch between an opening state and a closed state is disposed in an accommodating cavity such that the opening of the storage box may not be affected by an external environment. Moreover, the cover opening structure does not occupy the original space of the vehicle such that the storage box is suitable for use in the vehicle.

Other functions of the storage box and the vehicle provided in the present disclosure will be described in part in the following description. According to the description, the contents presented by reference numerals and examples will be apparent for those of ordinary skill in the art. Creative aspects of the storage box and the vehicle provided in the present disclosure may be fully understood by practice or by using the methods, devices, and combinations described in the following detailed examples.

### BRIEF DESCRIPTION OF THE DRAWINGS

To describe the technical solutions in some exemplary embodiments of this disclosure more clearly, the following briefly describes the accompanying drawings required for describing some exemplary embodiments. Apparently, the accompanying drawings in the following description show merely some exemplary embodiments of this disclosure, and a person of ordinary skill in the art may still derive other drawings from these accompanying drawings without creative efforts.

FIG. 1 is an oblique view of a storage box provided according to some exemplary embodiments of the present disclosure;

FIG. 2 is an exploded view of a storage box provided according to some exemplary embodiments of the present disclosure;

FIG. 3 is a front view of a storage box in a closed state provided according to some exemplary embodiments of the present disclosure;

FIG. 4 is a sectional view A-A of FIG. 3;

FIG. 5 is a front view of a storage box in a half-opening state provided according to some exemplary embodiments of the present disclosure; and

FIG. 6 is a front view of a storage box in a fully opening state provided according to some exemplary embodiments of the present disclosure.

### DETAILED DESCRIPTION

The following description provides specific application scenarios and requirements of this disclosure, to enable a person skilled in the art to make and use content of this disclosure. Various partial modifications to the disclosed exemplary embodiments would be obvious to a person skilled in the art. General principles defined herein can be applied to other embodiments and applications without departing from the spirit and scope of this disclosure. Therefore, this disclosure is not limited to the illustrated embodiments, but is to be accorded the widest scope consistent with the claims.

The terms used herein are only intended to describe specific exemplary embodiments and are not restrictive. For example, as used herein, singular forms “a”, “an”, and “the” may also include plural forms, unless otherwise clearly specified in a context. When used in this disclosure, the terms “comprise”, “include”, and/or “contain” indicate the presence of associated features, integers, steps, operations, elements, and/or components, but do not exclude the presence of one or more other features, integers, steps, operations, elements, components, and/or groups or addition of other features, integers, steps, operations, elements, components, and/or groups to the system/method.

In view of the following description, these features and other features of this disclosure, operations and functions of related elements of structures, and economic efficiency in combining and manufacturing components can be significantly improved. All of these form a part of this disclosure with reference to the drawings. However, it should be understood that the drawings are only for illustration and description purposes and are not intended to limit the scope of this disclosure. It should also be understood that the drawings are not drawn to scale.

Flowcharts used in this disclosure show operations implemented by a system according to some exemplary embodiments of this disclosure. It should be understood that operations in the flowcharts may be implemented not in the order as shown. Conversely, the operations may be implemented in a reverse order or simultaneously. In addition, one or more other operations may be added to the flowcharts, and one or more operations may be removed from the flowcharts.

In this disclosure, “X includes at least one of A, B, or C” means: X includes at least A, or X includes at least B, or X includes at least C. In other words, X may include only any one of A, B, and C, or may include any combination of A, B, and C, and other possible content or elements. Any combination of A, B, and C may be A, B, C, AB, AC, BC, or ABC.

In the present disclosure, unless otherwise explicitly specified, an association relationship between structures may be a direct association relationship or an indirect association relationship. For example, for the description “A is connected to B”, unless it is explicitly described that A is directly connected to B, it will be construed as that A may be directly connected to B or indirectly connected to B. In another example, for the description “A is over B”, unless it is explicitly described that A is directly above B (A and B are adjacent and A is above B), it will be construed as that A may be directly above B, or A may be indirectly over B (A and B are spaced apart by other element and A is above B), and so on.

A storage box provided in the present disclosure may be configured to store articles. The storage box may be mounted on a vehicle, in particular a short-distance commuter vehicle, such as a kick-scooter, a tricycle, a self-balanced scooter, a bicycle, and an electric cart.

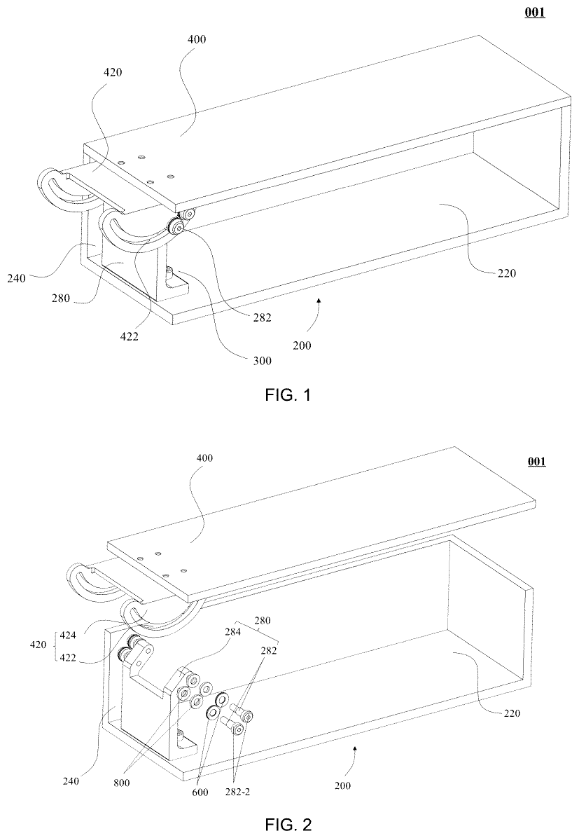

FIG. 1 is an oblique view of a storage box 001 provided according to some exemplary embodiments of the present disclosure. As shown in FIG. 1, the storage box 001 may include a box body 200 and a box cover 400. The box cover 400 can be disposed to cover the box body 200 to form an accommodating cavity 220 with the box body 200. The accommodating cavity 220 may be configured to accommodate an object(s). A shell 240 of the box body 200 may include a sidewall(s) and a bottom wall. The sidewall is connected with the bottom wall to form the accommodating cavity 220. A shape defined by the sidewall may be any shape, such as a cylinder, a cube, a cuboid, and a prism.

The storage box 001 may further include a cover opening structure 300. The cover opening structure 300 is configured such that the cover opening structure 300 is capable of guiding the box cover 400 to switch from a closed state to an opening state in which the accommodating cavity 220 is opened, or guiding the box cover 400 to switch from the opening state to the closed state.

It needs to be noted here that a function of the cover opening structure 300 for the box cover 400 is to define a moving path of the box cover 400 so that the box cover 400 can switch between the closed state and the opening state. Herein, the cover opening structure 300 itself may have a driving force to autonomously drive the box cover 400 to move. The cover opening structure 300 itself may have no driving force but can drive the box cover 400 to move under a synergistic action of an external force. Therefore, the “guide” mentioned herein may be understood as a tendency of the cover opening structure 300 to the box cover 400 so that the box cover 400 can be switched between the closed state and the opening state when driven by the cover opening structure 300 or under the action of an external force.

The storage box 001 in the embodiments of the present disclosure has the following advantages: the cover opening structure 300 for guiding the box cover 400 to switch between the opening state and the closed state is disposed in the accommodating cavity 220 such that the opening of the storage box 001 is not affected by an external environment. Moreover, the cover opening structure 300 does not occupy the original space of the vehicle such that the storage box 001 is suitable for use in the vehicle.

In some exemplary embodiments of the present disclosure, the cover opening structure 300 may have a portion formed on the box body 200 and another portion formed on the box cover 400. The moving of the box cover 400 may be achieved by the cooperation between the two portions of the cover opening structure 300. In addition, the cover opening structure 300 is disposed separately on the box body 200 and the box cover 400 so that the internal space of the storage box 001 can be effectively utilized. Accordingly, a portion of the cover opening structure 300 may move along with the box cover 400 at least when the box cover 400 is switched to the opening state, facilitating placement of articles and the like into the accommodating cavity 220.

In some exemplary embodiments, the cover opening structure 300 may be switched between the closed state and the opening state in a manner of guiding the box cover 400 to flip outwards relative to the box body 200. For example, a first hinged portion 280 may be disposed on the shell 240 of the box body 200. The first hinged portion 280 may be configured for hinged connection between the box body 200 and the box cover 400. The first hinged portion 280 may be disposed at any position of the shell 240, i.e., may be disposed in any location on the sidewall or bottom wall of the shell 240. For example, when the shape defined by the sidewall is a cuboid, the first hinged portion 280 may be disposed at a long edge of the sidewall or on a short edge of the sidewall. The first hinged portion 280 may be integrally formed with the shell 240 of the box body 200, or may be mounted on the shell 240 of the box body 200 in a fixed connection manner. The fixed connection may be implemented in various ways, such as threaded connection, welding, riveting, and snap-fit.

The box cover 400 may cooperate with the box body 200 to open or close the accommodating cavity 220. The box cover 400 may include a second hinged portion 420. The second hinged portion 420 may be hinged with the first hinged portion 280 to form the cover opening structure 300 so that the box cover 400 can rotate about a hinged position of the first hinged portion 280 and the second hinged portion 420 relative to the box body 200 so as to open or close the accommodating cavity 220, thereby realizing storage of an object in the accommodating cavity 220. The second hinged portion 420 may be integrally formed with the box cover 400, or may be mounted on the box cover 400 in a fixed connection manner. The fixed connection may be implemented in various ways, such as threaded connection, welding, riveting, and snap-fit.

One of the first hinged portion 280 and the second hinged portion 420 may include a hinge, while the other one may include a hinge support. The hinge may be rotatably connected with the hinge support so that the box cover 400 can rotate about the hinged position of the first hinged portion 280 and the second hinged portion 420 relative to the box body 200 so as to open or close the accommodating cavity 220. For example, the first hinged portion 280 may be a hinge, and the second hinged portion 420 may be a hinge support. The first hinged portion 280 may also be a hinge support, and the second hinged portion 420 may be a hinge. For ease of description, the following description will be made by taking the second hinged portion 420 including the hinge and the first hinged portion 280 including the hinge support as an example. A person skilled in the art can understand that the second hinged portion 420 including a hinge support and the first hinged portion 280 including a hinge shall also fall within the scope of protection of the present disclosure.

As shown in FIG. 1, the second hinged portion 420 (i.e., the hinge 420) may be provided with a circular arc-shaped sliding groove 422. The circular arc-shaped sliding groove 422 may be an annular track penetrating through the hinge 420. A connecting shaft 282 may be disposed on the first hinged portion 280 (i.e., the hinge support 280). The connecting shaft 282 may be configured to pass through the circular arc-shaped sliding groove 422 and move along the circular arc-shaped sliding groove 422 such that the box cover 400 can rotate relative to the sidewall 240 of the box body 200 to open or close the storage box 001. A radius and a length of the circular arc-shaped sliding groove 422 may be determined according to a size and a maximum opening angle of the storage box 001. When the hinge 420 is rotatably connected with the hinge support 280, the box cover 400 may rotate about an axis passing through a center of circle of the circular arc-shaped sliding groove 422.

A number of the first hinge supports 280 matches, i.e., is equal to, a number of the second hinged portions 420. One hinge 420 and one hinge support 280 are matched to form a group. There may be one group or a plurality of groups (such as 2 groups, 3 groups, or even more groups) of first hinge supports 280 and second hinged portions 420. For ease of description, the following description will be made by taking 2 groups of first hinge supports 280 and second hinged portions 420 as an example. A person skilled in the art can understand that other numbers of the first hinge supports 280 and the second hinged portions 420 shall also fall within the scope of protection of the present disclosure. It needs to be noted that the following description for the hinge 420 and the hinge support 280 is for one group of hinge 420 and hinge support 280.

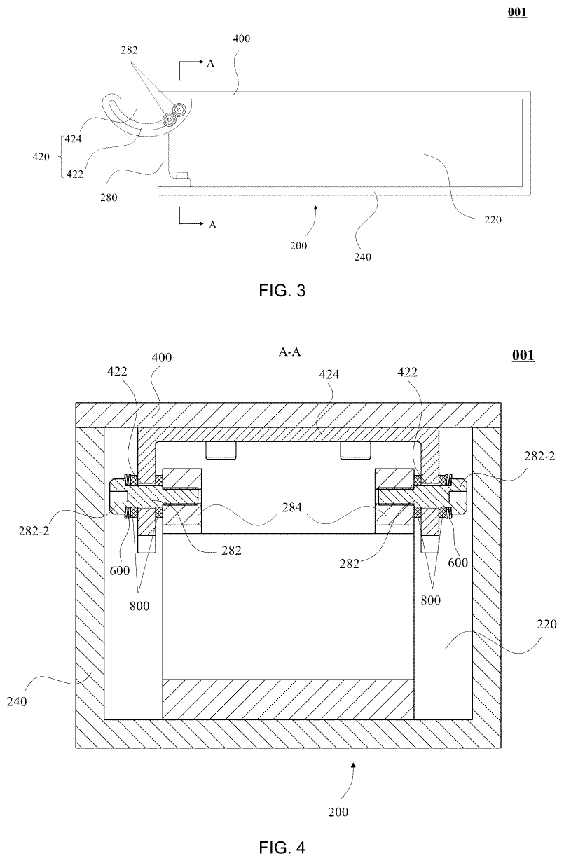

FIG. 2 is an exploded view of a storage box 001 provided according to some exemplary embodiments of the present disclosure; FIG. 3 is a front view of a storage box 001 in a closed state provided according to some exemplary embodiments of the present disclosure; and FIG. 4 is a sectional view A-A of FIG. 3. As shown in FIG. 2 to FIG. 4, the hinge 420 may include a hinge body 424 and the circular arc-shaped sliding groove 422. The circular arc-shaped sliding groove 422 may be an annular track penetrating through the hinge body 424. The circular arc-shaped sliding groove 422 may provide a motion trajectory so that the hinge 420 and the hinge support 280 can move along the trajectory of the circular arc-shaped sliding groove 422. In some exemplary embodiments, the circular arc-shaped sliding groove 422 may be a portion of a ring. In some exemplary embodiments, the circular arc-shaped sliding groove 422 may also be a portion of any curve, e.g., an ellipse. In some exemplary embodiments, the circular arc-shaped sliding groove 422 may also be linear. As shown in FIG. 2 to FIG. 4, the hinge support 280 may include a hinge support body 284 and the connecting shaft 282.

The connecting shaft 282 may pass through the circular arc-shaped sliding groove 422. A size and a cross-sectional shape of a portion of the connecting shaft 282 that is in slip connection with the circular arc-shaped sliding groove 422 match a width of the circular arc-shaped sliding groove 422. A limiting portion 282-2 is disposed at one end of the connecting shaft 282, and the other end of the connecting shaft is fixedly connected with the hinge support body 284. There may be a plurality of ways of fixed connection, such as threaded connection, sticking, welding, and riveting. The limiting portion 282-2 and the hinge support body 284 may abut against two sides of the hinge body 424, respectively, to limit the movement of the hinge body 424 in an axial direction of the connecting shaft 282 relative to the hinge support body 284. The connection of the connecting shaft 282 and the circular arc-shaped sliding groove 422 may enable the connecting shaft 282 to move along the trajectory of the circular arc-shaped sliding groove 422, i.e., the circular arc-shaped sliding groove 422 can provide a determined trajectory for relative motion between the connecting shaft 282 and the circular arc-shaped sliding groove 422. There may be one, or a plurality of (such as 2, 3, or even more) connecting shafts 282. A plurality of connecting shafts 282 may be arranged along the direction of the circular arc-shaped sliding groove 422 so that the plurality of connecting shafts 282 can all be disposed to pass through the circular arc-shaped sliding groove 422. In some exemplary embodiments, the connecting shaft 282 may be a shaft shoulder screw.

As shown in FIG. 2 to FIG. 4, the storage box 001 may further include an elastic device 600. The elastic device 600 may be located between the hinge 420 and the hinge support 280 and in a compressed state to provide a damping force for rotation of the box cover 400 such that the box cover 400 is capable of staying at any angle. For example, the elastic device 600 may be located between the limiting portion 282-2 and the hinge body 424 and in the compressed state. The elastic device 600 may also be located between the hinge support body 284 and the hinge body 424 and in the compressed state. The connecting shaft 280 may be disposed to pass through the elastic device 600. The elastic device 600 may include at least one of a compression spring, a disc spring, or an elastic rubber.

Since the elastic device is located between the hinge 420 and the hinge support 280 and is in the compressed state, the elastic device 600 may provide a pressure to the hinge 420 and the hinge support 280. Due to the existence of the pressure, when the hinge 420 and the hinge support 280 move relatively, the pressure will provide a force of friction between the hinge 420 and the hinge support 280. A moment of resistance generated by the force of friction is greater than a moment generated due to gravity when the box cover 400 rotates so that the box cover 400 can stay at any angle without falling down.

The storage box 001 may further include at least one wear pad 800. The at least one wear pad 800 may be located between the hinge 420 and the hinge support 280 to reduce wear caused by relative rotation between the hinge 420 and the hinge support 280. The connecting shaft 282 may pass through a mounting hole of the at least one wear pad 800. As described previously, the hinge support 280 may abut against two sides of the hinge 420. For example, the limiting portion 282-2 and the hinge support body 284 abut against two sides of the hinge body 424, respectively. Moreover, the elastic device 600 may provide a pressure to the hinge 420 and the hinge support 280. In order to reduce wear caused by a force of friction when the hinge 420 and the hinge support 280 rotate relatively, the storage box 001 may be provided with at least one wear pad 800 between the hinge 420 and the hinge support 280. The hinge 420 and the hinge support 280 are spaced apart by the at least one wear pad 800 such that the two sides of the hinge 420 separately abut against the hinge support 280 by the at least one wear pad 800 to reduce wear. For example, the at least one wear pad 800 may be located on the two sides of the hinge body 424 such that the two sides of the hinge body 424 abut against the limiting portion 282-2 and the hinge support body 284 by the at least one wear pad 800, respectively. A material of the at least one wear pad 800 may be nylon, polyoxymethylene (POM), bronze, etc.

In some exemplary embodiments, the wear pad 800 may be integrally formed with the connecting shaft 280. For example, the connecting shaft 280 may be a shoulder screw with a pad.

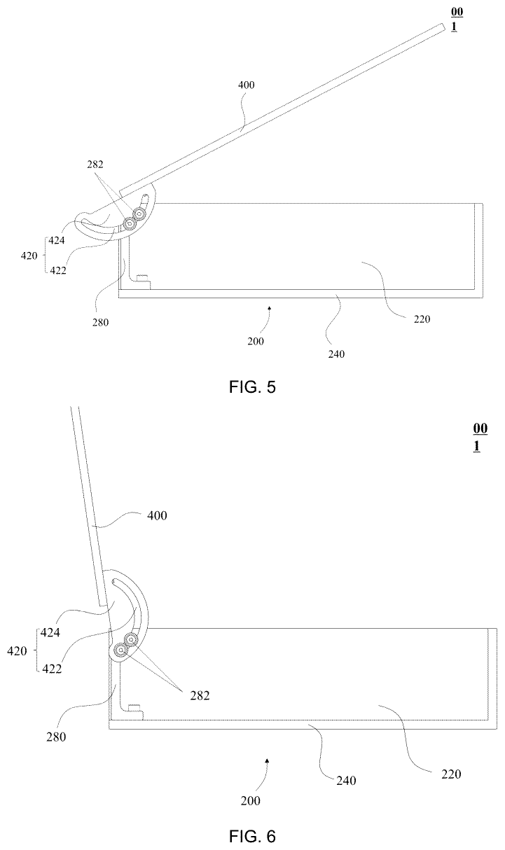

FIG. 5 is a front view of a storage box 001 in a half-opening state provided according to some exemplary embodiments of the present disclosure; and FIG. 6 is a front view of a storage box 001 in a full opening state provided according to some exemplary embodiments of the present disclosure. As shown in FIG. 5 and FIG. 6, when the box cover 400 is opened, the box cover 400 causes the hinge 420 to move with it. The connecting shaft 282 fixed to the hinge support body 284 slides along the circular arc-shaped sliding groove 422 of the hinge 420 such that the box cover 400 rotates about an axis passing through a center of circle of the circular arc-shaped sliding groove 422. The axis passing through the center of circle of the circular arc-shaped sliding groove 422 may be a virtual rotating shaft of the hinge 420. Since the elastic device is located between the hinge 420 and the hinge support 280 and is in the compressed state, the elastic device 600 may provide a pressure to the hinge 420 and the hinge support 280. Due to the existence of the pressure, when the hinge 420 and the hinge support 280 move relatively, the pressure may have a force of friction between the hinge 420 and the hinge support 280. A moment of resistance generated by the force of friction is greater than a moment generated due to gravity when the box cover 400 rotates so that the box cover 400 can stay at any angle without falling down (as shown in FIG. 5 for example).

As shown in FIG. 3, when the box cover 400 is closed, the connecting shaft 280 may be located at a first end of the circular arc-shaped sliding groove 422. As shown in FIG. 6, when the box cover 400 is fully opened, the connecting shaft 280 is located at a second end of the circular arc-shaped sliding groove 422.

In the foregoing exemplary embodiments, the cover opening structure 300 itself may have no driving force, and the closing or opening of the box cover 400 may be achieved by an external force acting on the box cover 400. In such a case, the storage box 001 may also include a drive structure (not shown in the figures). The drive structure may be connected between the box body 200 and the box cover 400. The drive structure is configured to apply a force to the box cover 400 such that the box cover 400 can be guided by the cover opening structure 300 to move automatically. The drive structure may be an electrical element or mechanism capable of acting on the box cover 400, such as an electric drive pusher, an air cylinder, an oil cylinder, and a drive motor. Moreover, the drive structure may be disposed on the box body 200, and an acting force output by the drive structure can directly act on the box cover 400.

Of course, in addition to the above-mentioned cover opening structure 300 that is formed by the first hinged portion 280 and the second hinged portion 420 and does not have a driving force, the cover opening structure 300 may also be designed to include a driving force.

For example, in some exemplary embodiments, the cover opening structure 300 may include a built-in rotating shaft and a first pushing mechanism. The built-in rotating shaft is disposed on the box cover 400. Two ends of the built-in rotating shaft are concealably assembled on two side faces of the box body 200 that are located within the accommodating cavity 220. The first pushing mechanism is configured to push the box cover 400 to rotate around the built-in rotating shaft. In this case, the first pushing mechanism is capable of acting on the box cover 400 to enable the box cover 400 to rotate around the built-in rotating shaft so as to open the accommodating cavity 220.

In particular, in some exemplary embodiments, the built-in rotating shaft may be embedded into the box cover 400 having a certain thickness with only two ends of the built-in rotating shaft being exposed, and the two ends can be correspondingly mounted in two sidewalls of the box body 200. In some exemplary embodiments, the built-in rotating shaft may also be partially embedded in the box cover 400, e.g., partially embedded in the bottom of the box cover 400, and the built-in rotating shaft protrudes from a bottom surface of the box cover 400. In some exemplary embodiments, the built-in rotating shaft may also be directly connected to the bottom surface of the box cover 400, and this connection manner includes, but is not limited to, screw connection, adhesive connection, and the like.

The first pushing mechanism may be an electrical element or mechanism capable of acting on the box cover 400, such as an electric pusher, an air cylinder, an oil cylinder, and a drive motor.

In some exemplary embodiments of the present disclosure, the cover opening structure 300 is integrally disposed on the box body 200. This design can simplify assembling and simplify the production process, in which the cover opening structure 300 is integrally designed and formed and then mounted on the box body 200.

The cover opening structure 300 is switched between the closed state and the opening state in a manner of driving the box cover 400 to move outwards along a straight line relative to the box body 200. The cover opening structure 300 may use a second pushing mechanism. The second pushing mechanism may be an electrical element or mechanism capable of acting on the box cover 400, such as an electric drive pusher, an air cylinder, an oil cylinder, and a drive motor.

The present disclosure further provides a vehicle. The vehicle may be a kick-scooter, a tricycle, a self-balanced scooter, a bicycle, or an electric cart. The vehicle may include a vehicle body and a storage box 001 provided in the present disclosure.

The vehicle body may be a base and a main body structure of the vehicle. The vehicle body may be configured to connect various parts and components of the vehicle, and may also be configured to carry a user. The storage box 001 may be mounted on the vehicle body.

It needs to be noted that the details of the storage box 001 of a vehicle not disclosed in the device embodiments of the present disclosure may be found in the drawings of the present disclosure, which will not be repeated herein.

In conclusion, in the storage box 001 and the vehicle provided in the present disclosure, the circular arc-shaped sliding groove 422 is disposed on one of the box body 200 and the box cover 400, while the connecting shaft 282 is disposed on the other one, and the connecting shaft 282 passes through the circular arc-shaped sliding groove 422 so that the connecting shaft 282 can move along the circular arc-shaped sliding groove 422. Thus, the box cover 400 can rotate relative to the box body 200 to open or close the storage box 001. The storage box 001 provided in the present disclosure provides a concealed damping hinge. The real rotating shaft is replaced by a sliding rail. Relative rotation of two components around a virtual rotating shaft is realized, and a damping effect is achieved. The storage box 001 provided in the present disclosure has the advantages of simple and reliable structure, low cost, and the box cover 400 being capable of staying at any position.

The foregoing describes some specific exemplary embodiments of the present disclosure. Other embodiments fall within the scope of the appended claims. In some cases, the actions or steps set forth in the claims may be performed in sequences different from those shown in the exemplary embodiments and may still achieve expected results. In addition, the processes depicted in the accompanying drawings do not necessarily require the specific orders or sequential orders shown for achieving the expected results. In some implementations, multitasking and parallel processing are also possible or may be advantageous.

In summary, after reading this detailed disclosure, a person skilled in the art can understand that the foregoing detailed disclosure is presented by way of example only, but it is not limited thereto. In addition, a person skilled in the art can understand that the present disclosure intends to cover various changes, improvements and modifications of the embodiments. These changes, improvements and modifications are intended to be covered in this disclosure and are within the spirit and scope of this disclosure.

In addition, some specific terms in this disclosure have been used to describe the exemplary embodiments of this disclosure. For example, “one embodiment”, “an embodiment” and/or “some embodiments” mean that a specific feature, structure, or characteristic described in the embodiment(s) may be included in at least one embodiment of the present disclosure. Therefore, it can be emphasized and should be understood that two or more references to “an embodiment” or “one embodiment” or “an alternative embodiment” in various parts of this disclosure do not necessarily all refer to the same embodiment. In addition, specific feature, structure, or characteristic may be appropriately combined in one or more embodiments of the present disclosure.

It should be understood that in the foregoing description of exemplary embodiments of the present disclosure, to help understand a feature, and for the purpose of simplifying the present disclosure, the present disclosure sometimes combines various features in a single embodiment, a drawing, or description thereof. However, this does not mean that the combination of these features is necessary. It is possible for a person skilled in the art to mark some of the devices as a single embodiment for understanding when reading this disclosure. In other words, some exemplary embodiments in this disclosure can also be understood as an integration of multiple sub-embodiments. It is also possible that each sub-embodiment has less than all of the features of a single preceding disclosed embodiment.

Each patent, patent application, publication of patent applications, and other materials referenced in this disclosure, such as articles, books, specifications, publications, documents, articles, etc., except for any historical litigation documents related thereto, any identical historical litigation documents that may be inconsistent or conflicting with this disclosure, or any identical historical litigation documents that may have a restrictive effect on the widest scope of the claims may be incorporated herein by reference and used for all purposes now or in the future associated with this disclosure. In addition, if the description, definition, and/or use of terms in any associated materials contained herein is inconsistent with or in conflict with that in this document, the terms in this document shall prevail.

Finally, it should be understood that the embodiments disclosed herein is an explanation of the principles of the present disclosure. Other modified embodiments are also within the scope of this disclosure. Therefore, the embodiments disclosed in this disclosure are merely examples rather than limitations. A person skilled in the art can adopt alternative configurations according to the embodiments of the present disclosure in order to implement this disclosure. Therefore, the embodiments of this disclosure are not limited to those explicitly described herein.

What is claimed is:

1. A storage box, comprising:
a box body;
a box cover disposed to cover the box body and forming an accommodating cavity with the box body, wherein the accommodating cavity is configured to accommodate an object; and
a cover opening structure disposed in the accommodating cavity, wherein
the cover opening structure is configured to guide the box cover to switch from a closed state to an opening state so as to open the accommodating cavity, or guide the box cover to switch from the opening state to the closed state.

2. The storage box according to claim 1, wherein the cover opening structure has a portion formed on the box body and another portion formed on the box cover.

3. The storage box according to claim 2, wherein the cover opening structure is switched between the closed state and the opening state in a manner of guiding the box cover to flip outwards relative to the box body.

4. The storage box according to claim 3, wherein a first hinged portion is disposed on a shell of the box body; the box cover includes a second hinged portion; and the first hinged portion and the second hinged portion form the cover opening structure,
wherein one of the first hinged portion and the second hinged portion includes a hinge, and the other one of the first hinged portion and the second hinged portion includes a hinge support, the hinge has a circular arc-shaped sliding groove, a connecting shaft is disposed on the hinge support, and the connecting shaft is disposed to pass through the circular arc-shaped sliding groove and is movable along the circular arc-shaped sliding groove, such that the box cover is rotatable relative to the box body to open or close the storage box.

5. The storage box according to claim 4, wherein the shell of the box body includes a sidewall and a bottom wall; and the sidewall is connected with the bottom wall to form the accommodating cavity.

6. The storage box according to claim 4, wherein the second hinged portion includes the hinge, and the first hinged portion includes the hinge support.

7. The storage box according to claim 4, wherein the hinge includes a hinge body and the circular arc-shaped sliding groove; and the circular arc-shaped sliding groove penetrates through the hinge body.

8. The storage box according to claim 7, wherein the hinge support includes a hinge support body and the connecting shaft; the connecting shaft is passes through the circular arc-shaped sliding groove; a limiting portion is disposed at one end of the connecting shaft, and another end of the connecting shaft is fixedly connected to the hinge support body; and the limiting portion and the hinge support body abut against two sides of the hinge body, respectively.

9. The storage box according to claim 4, further comprising:
an elastic device located between the hinge and the hinge support, wherein the elastic device is in a compressed state to provide a damping force for the box cover to rotate, so as to enable the box cover to stay at any angle, and the connecting shaft passes through the elastic device.

10. The storage box according to claim 9, wherein the elastic device includes at least one of a compression spring, a disc spring, or an elastic rubber.

11. The storage box according to claim 4, further comprising:
at least one wear pad located between the hinge and the hinge support to reduce wear caused by relative rotation between the hinge and the hinge support,
wherein the connecting shaft passes through a mounting hole on the at least one wear pad.

12. The storage box according to claim 4, wherein when the box cover is closed, the connecting shaft is located at a first end of the circular arc-shaped sliding groove; and when the box cover is fully opened, the connecting shaft is located at a second end of the circular arc-shaped sliding groove.

13. The storage box according to claim 1, further comprising:
a drive structure connected between the box body and the box cover, wherein the drive structure is configured to apply a force to the box cover such that the box cover is guided by the cover opening structure to move.

14. The storage box according to claim 3, further comprising:
a built-in rotating shaft disposed on the box cover, wherein two ends of the built-in rotating shaft are concealably mounted on two side faces of the box body located within the accommodating cavity; and
a first pushing mechanism configured to push the box cover to rotate around the built-in rotating shaft, wherein the first pushing mechanism and the built-in rotating shaft form the cover opening structure.

15. The storage box according to claim 1, wherein the cover opening structure is integrally disposed on the box body.

16. The storage box according to claim 15, wherein the cover opening structure is switched between the closed state and the opening state in a manner of driving the box cover to move outwards along a straight line relative to the box body.

17. The storage box according to claim 16, wherein the cover opening structure includes:
a second pushing mechanism configured to push the box cover.

18. A vehicle, comprising:
a vehicle body, wherein
the vehicle body includes a storage box, and the storage box includes:
a box body,
a box cover disposed to cover the box body and forming an accommodating cavity with the box body, wherein the accommodating cavity is configured to accommodate an object, and
a cover opening structure disposed in the accommodating cavity, wherein
the cover opening structure is configured to guide the box cover to switch from a closed state to an opening state so as to open the accommodating cavity, or guide the box cover to switch from the opening state to the closed state.

19. The vehicle according to claim 18, wherein the cover opening structure has a portion formed on the box body and another portion formed on the box cover.

20. The vehicle according to claim 19, wherein the cover opening structure is switched between the closed state and the opening state in a manner of guiding the box cover to flip outwards relative to the box body.
